(19) United States
(12) Patent Application Publication
(10) Pub. No.: US 2019/0361569 A1
(43) Pub. Date: Nov. 28, 2019

(54) INTERACTIVE SCREEN DEVICES, SYSTEMS, AND METHODS

(71) Applicant: Ubi interactive inc., Seattle, WA (US)

(72) Inventors: Chao Zhang, Seattle, WA (US); Anup Koyadan Chathoth, Seattle, WA (US)

(21) Appl. No.: 16/368,784

(22) Filed: Mar. 28, 2019

Related U.S. Application Data
(60) Provisional application No. 62/649,288, filed on Mar. 28, 2018.

(51) Int. Cl. G06F 3/042; G03B 21/14; G03B 21/10

(52) U.S. Cl. CPC G06F 3/0425; G03B 21/10; G03B 21/14

(57) ABSTRACT

An interactive display system is described. An example interactive display system includes a laser plane generator that includes laser pane generating device. The generator further includes a laser oriented to emit a beam of infrared light towards the laser plane generating device, which transforms the beam into a plane of infrared light. The plane generating device may be or include a cone mirror, rod lens, or other optical device that can transform a laser beam into a line or plane. The system further includes an imaging device senses the infrared light produced by the laser and detect a reflection produced by an object that breaks the plane of infrared light.

### CROSS-REFERENCE TO RELATED APPLICATION

This application claims the benefit of U.S. Provisional Patent Application No. 62/649,288, entitled “Systems and Methods for Providing an Interactive Screen” and filed Mar. 28, 2018, the content of which is incorporated herein by reference in its entirety.

### TECHNICAL FIELD

The present disclosure relates to methods, techniques, and systems for creating an interactive screen on surfaces.

### BACKGROUND

There are several technologies and methods available to turn a projected display or a physical display screen such as an LCD screen or Plasma TV to an interactive screen. Most of these approaches require hardware and sensors that are deeply embedded in the display hardware. The disadvantage of these systems is that they are often very inflexible since they are closely coupled with the hardware and specially calibrated for specific physical position and size.

A more cost-effective and flexible approach is to use add on hardware and software that can work with various type of display technologies and sizes. The specific system covered by this disclosure deals with a vision-based approach. In order to make a projected and physical display interactive, one option is to project an invisible laser plane parallel to the surface of the display. When the user's hand or other input objects touches this laser plane a disruption is created in the laser plane, which then can be captured and tracked using an imaging system. A software algorithm then can be used to determine the exact position of this disruption with respect to the display coordinates. The basic approach of the system including a projected laser plane has been known for decades and have been used in various systems such as projected keyboards. Another option is to use an active light source, such as led pen, laser pointer, led light that can create an invisible light blob close to the surface. An imaging system will track the light blob and a software algorithm will be used to calculate and map the position of the light blob to the screen behind it.

This disclosure describes—methods to improve the hardware to make it more usable and precise, methods to make this hardware work on TV screens (not just projectors), methods to set up the device very precisely to make sure that user experience is optimal, software features to make the technology more usable and precise.

### BRIEF DESCRIPTION OF THE DRAWINGS

FIG. 1 illustrates components of the interactive display system.

FIG. 2 illustrates an example physical embodiment of the interactive display system.

FIG. 3 illustrates an emitter with visible and invisible lasers.

FIG. 4 illustrates a spring-loaded self-aligned laser plane generator.

FIG. 5 illustrates an embodiment of a camera module configured to switch between an infrared view and visible light view, and to send signals to other modules, such as a laser, pen, or finger cap input device.

FIG. 6 illustrates an example finger cap input object.

FIG. 7 illustrates an example base plate for mounting a laser plane generator.

FIG. 8 illustrates an example touchscreen system mounted to a whiteboard.

FIG. 9 illustrates an example touchscreen system mounted to a wall

FIGS. 10 and 11 illustrate example interactive rear-projection systems with imaging sensors set behind the projection surface.

FIG. 12 illustrates an example interactive projection on a horizontal surface.

FIG. 13 illustrates an example of vertical interaction by placing an interactive display device in a horizontal configuration.

FIG. 14 illustrates an example square block laser plane emitter with a cyclidic lens.

FIG. 15 illustrates an example square block laser plane emitter with a three-point alignment system.

FIG. 16 illustrates an example laser plane generator that produces a laser curtain that is parallel to a display surface by aligning the bottom surface of the generator with the display surface.

FIG. 17 illustrates a laser plane emitter that includes a cone mirror and three-point alignment system.

FIG. 18 illustrates a laser plane emitter that includes stand-off legs.

FIG. 19 illustrates an emitter that generates visible and invisible infrared light.

FIG. 20 illustrates a sample calibration pattern.

FIG. 21 illustrates a projection screen as shown in an example camera preview.

FIG. 22 illustrates selection of four display corners.

FIG. 23 illustrates place markers installed at a predefined location (e.g., corners) of a screen or surface.

FIG. 24 illustrates crosshairs at markers in an infrared camera view.

FIG. 25 illustrates crosshairs displayed at a marker on a display surface.

FIG. 26 illustrates crosshairs at a fingertip in an infrared camera view.

FIG. 27 illustrates a portable pen setup.

FIG. 28 illustrates an example embodiment mounted on top of a television screen.

FIG. 29 illustrates multiple sensors and multiple cameras.

FIG. 30 illustrates a battery-powered laser generator placed at the center of a table or other horizontal surface.

FIG. 31 illustrates a laser generator placed at the side of a table.

FIG. 32 illustrates in-air gesture control.

FIG. 33 illustrates an embodiment configured to provide a touch-pad style interface.

FIG. 34 illustrates an embodiment configured to provide an interactive wall display.

FIG. 35 illustrates use of a finger cap or infrared pen when laser module cannot be attached to a wall.

FIG. 36 illustrates an infrared and visible laser clicker.

FIG. 37 illustrates use of an infrared and visible laser clicker.

FIG. 38 illustrates an emitter installed at a corner of a display.

FIG. 39 illustrates a side view of an emitter installed at corner of a display.

FIG. 40 illustrates views of a laser planer generator that includes an off-center cone mirror.

FIG. 41 illustrates a cone mirror laser planer generator with an alignment system.

FIG. 42 is an exploded view of a cone mirror laser plane generator.

FIG. 43 is an exploded view of a cone mirror laser plane generator with alignment wing.

FIG. 44 illustrates a misaligned laser plane generator.

FIG. 45 illustrates an alignment indicator that includes three light emitting diodes.

FIG. 46 illustrates an interaction area specified by a special mask.

FIG. 47 illustrates an example embodiment that provides interactivity to multiple connected devices.

FIG. 48 illustrates an example combination of multiple displays to form a larger display.

FIG. 49 illustrates a first example cone mirror laser plane generator.

FIG. 50 illustrates a second example cone mirror laser plane generator.

FIG. 51 illustrates cone mirror laser plane generation compared to a prior art approach.

FIG. 52 illustrates the use of multiple cameras to avoid occlusion.

FIG. 53 illustrates the installation of a first example embodiment to provide an interactive display for a television, sometimes referred to as the “pistol design.”

FIG. 54 illustrates the installation of a second example embodiment to provide an interactive display for a television, sometimes referred to as the “hinge design.”

FIG. 55 illustrates an example pen configuration.

FIG. 56 illustrates an example imaging device with the ability to communicate with and control a laser plane generator.

FIG. 57 illustrates example emitter alignments.

FIG. 58 illustrates an example of preferred emitter alignment.

FIG. 59 is a top view of emitter alignment.

FIG. 60 illustrates a homographic mapping between the corners of the display corners.

FIG. 61 illustrates a homographic mapping between sub-regions in a camera view and display area.

FIG. 62 illustrates an example embodiment of a laser plane generator that includes a flat surface for alignment with a display surface.

FIGS. 63A-63D illustrate an example embodiment of a laser plane generator that includes one or more springs for alignment with a display surface.

FIG. 64 illustrates an example embodiment of a laser plane generator that includes stand-off legs for alignment with a display surface.

FIGS. 65A-65D illustrate an example embodiment of a laser plane generator that includes one or more loaded springs for alignment with a display surface.

FIG. 66 illustrates an example embodiment of a laser plane generator that includes a wing member for alignment with a display surface.

FIG. 67A illustrates views of an example embodiment of a laser plane generator that includes a flat surface for alignment with a display surface.

FIG. 67B illustrates views of an example embodiment of a laser plane generator that includes one or more springs for alignment with a display surface.

FIG. 67C illustrates views of an example embodiment of a laser plane generator that includes stand-off legs for alignment with a display surface.

FIG. 67D illustrates views of an example embodiment of a laser plane generator that includes one or more loaded springs for alignment with a display surface.

FIGS. 68A-68C respectively illustrate perspective, top, and front views of a triple laser embodiment.

FIGS. 69A-69C respectively illustrate perspective, top, and front views of a double laser embodiment.

FIG. 70 illustrates components of an example laser plane generator.

FIG. 71 illustrates operation of a rod lens.

FIGS. 72A-72D illustrate views of example rod lens-based laser plane generators that utilize different alignment structures.

### DETAILED DESCRIPTION

Embodiments described herein provide enhanced computer- and network-based methods and systems for providing an interactive screen. The system comprises hardware and software components.

FIG. 1 is an example block diagram of different components of the system in an example embodiment. The main components of the system include the following 1) a computing device, 2) a display device 3) and an interactive screen system. The computing device runs specific application such as a presentation software or an internet browser that is displayed on a surface using a projection device or a physical display device. The interactive screen system includes hardware that is connected to the computing device and software that runs on the computing device or a designated computing unit.

The interactive screen system includes the following hardware components: 1) a laser plane generator that projects an invisible interaction layer close to the display surface, and 2) an imaging device that captures any disruption to the laser plane when finger or other objects interrupts the interaction layer (“laser curtain,” “laser plane”).

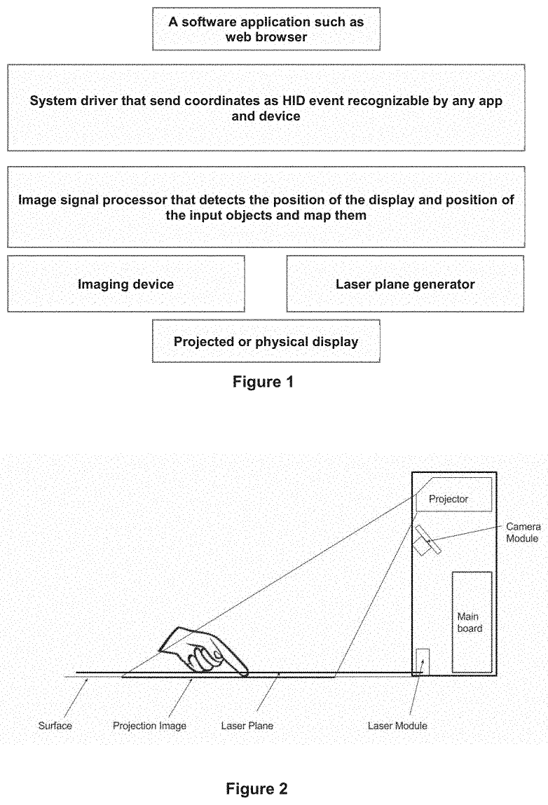

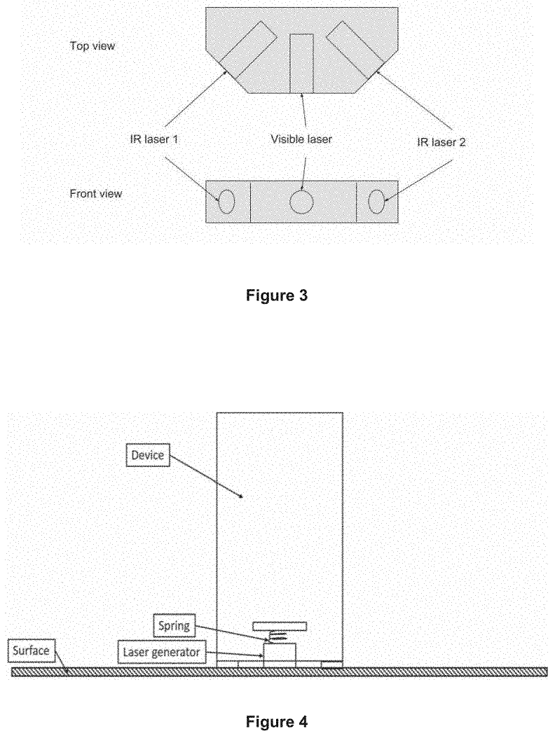

FIG. 2 illustrates an embodiment that is an integrated module that includes a housing that incorporates the imaging device (camera) and projector at a first (top) end of the housing, and a laser plane generator at a second (bottom) end of the housing. The main board includes logic (e.g., hardware or software) that performs techniques, processes, and methods described herein. The integrated module of FIG. 2 may be arranged in different ways to provide different styles of interaction. For example, in FIG. 13, the module is placed in a horizontal configuration to provide a vertical interaction surface.

It must be noted that the system can include and compose one or more display devices. The interactive screen system can also include and compose one or more laser plane generators and imaging devices.

### Laser Plane Generator

The laser plane generator projects an invisible interaction layer close to the display surface. An example embodiment of such a system uses infrared laser. In a typical embodiment, the infrared laser is a few millimeters thick and is positioned flush and parallel to the display surface. In typical embodiments, a laser beam is directed through a laser plane generating device, which transforms the beam into a line or plane. A laser plane generating device includes one or more lenses (e.g., a rod lens) or mirrors (e.g., a cone mirror). For the best user experience, there are several requirements to be satisfied by the laser plane generator.

To achieve the best accuracy, it is important that the laser beam is as thin, as parallel, and as flush to the display surface as possible. This ensures that a finger or other input object creates an input blob visible to the imaging device only when the input object is physically touching the display surface. This also makes sure that the input blob only appears at the tip of the input object so that the imaging device captures position of the input object as accurately as possible. It is also important that the laser plane generator emits the laser beam at an angle approaching or exceeding 180 degrees. This ensures that the laser plane generator can be placed very close to the top edge of the display.

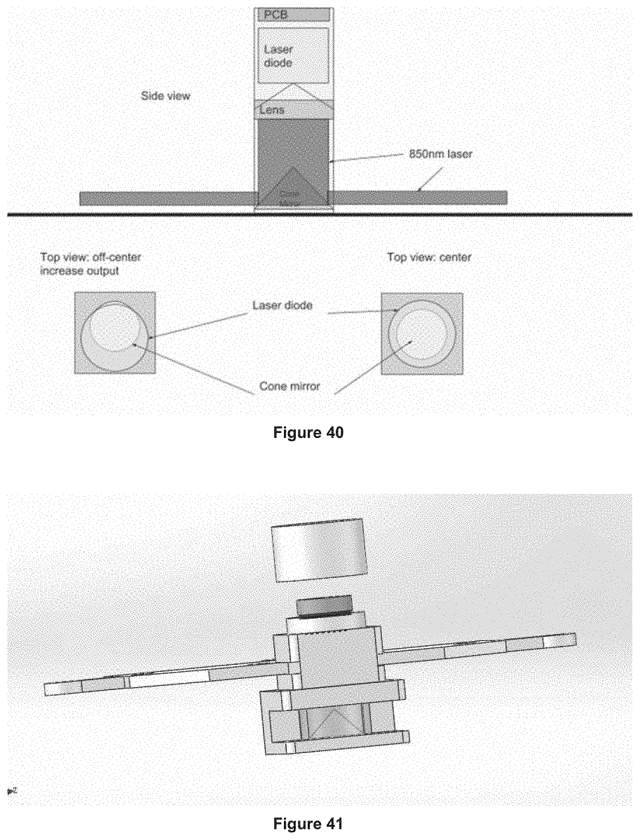

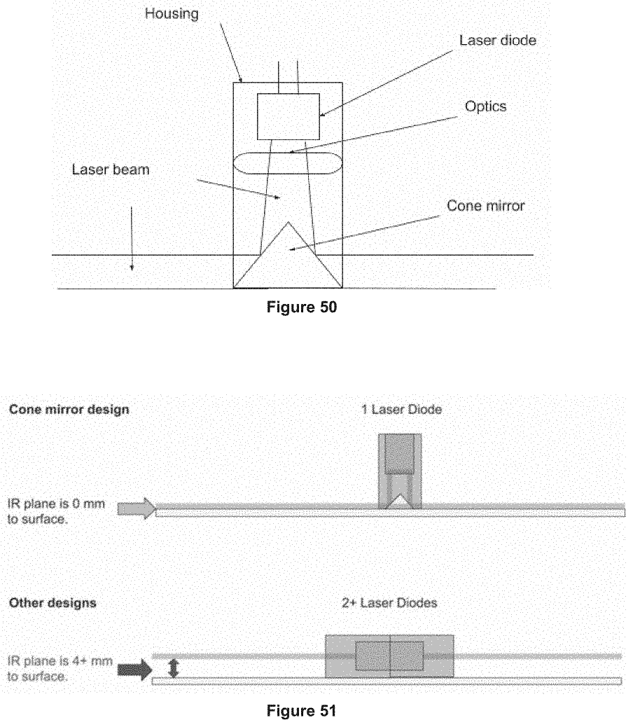

One embodiment provides a laser plane generator using a cone mirror and three-point alignment system as shown in FIG. 17. FIGS. 40, 65A-65D, and 67B-67D illustrate additional example laser plane generators that each utilize a cone mirror and a three-point alignment system. FIGS. 49-51 illustrate the operation of a cone mirror. A cone mirror design will allow the beam to be very close to the surface compared to traditional method, as shown in FIG. 51. A cone mirror is a 45-degree cone shaped mirror made of aluminum, glass or plastic. The cone mirror may be placed on the display surface directly. A laser diode is placed right above the cone mirror. A laser beam is formed from a laser diode after passing multiple lenses and shoots vertically down on to the cone mirror. The laser beam is then reflected out horizontally by the cone mirror and flush against the surface. The axis of the laser beam should be aligned and parallel with the axis of the cone mirror. Sometimes the beam is parallel but off-axis in order to create a plane closer to the display surface. The shape of the laser beam will impact the thickness of the plane. An oval shape beam will make sure the plane thickness is substantially the same across the 180 degrees.

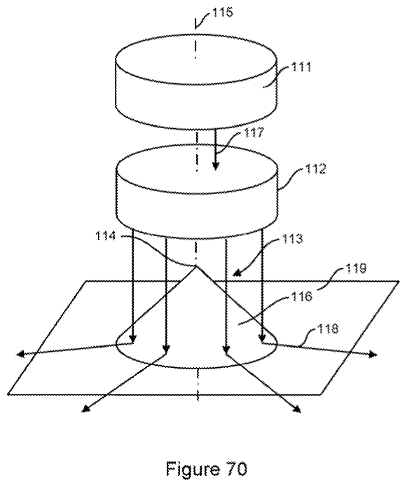

FIG. 70 illustrates components of an example laser plane generator. This embodiment includes a cone mirror 113 having an apex 114, a circular planar base, an axis 115 passing in a perpendicular direction through the center of the base and the apex 114, and a lateral surface 116 extending between the base and the apex. This embodiment also includes a laser 111 oriented to emit a beam 117 of infrared light parallel to the axis, through one or more lenses 112, and towards the lateral surface 116 of the cone mirror 113, wherein the lateral surface of the cone mirror reflects 118 the beam into a plane of infrared light that is perpendicular to the axis, parallel to the base, and between the base and the laser 111. The base of the cone mirror is flush against a display surface 119.

The base of the cone mirror 113 need not necessarily be in contact with the surface 119. In some embodiments, as discussed below, the generator may be aligned with the surface 119 by way of multiple support components. The support components are arranged to adjust the plane of the base of the cone mirror 113 with respect to the surface 119. Support components may include stand-off legs, screws, springs, or the like, as discussed further below.

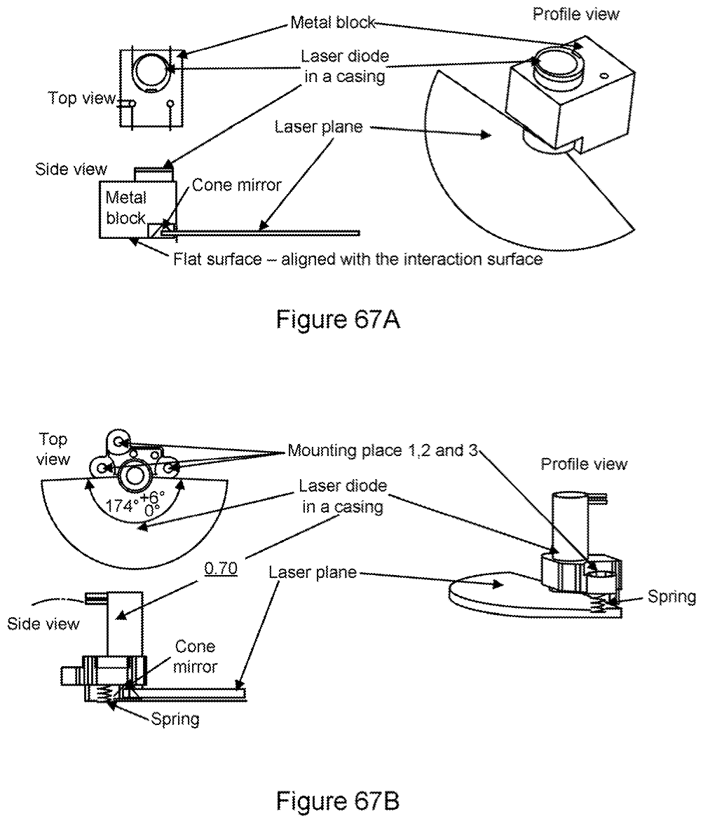

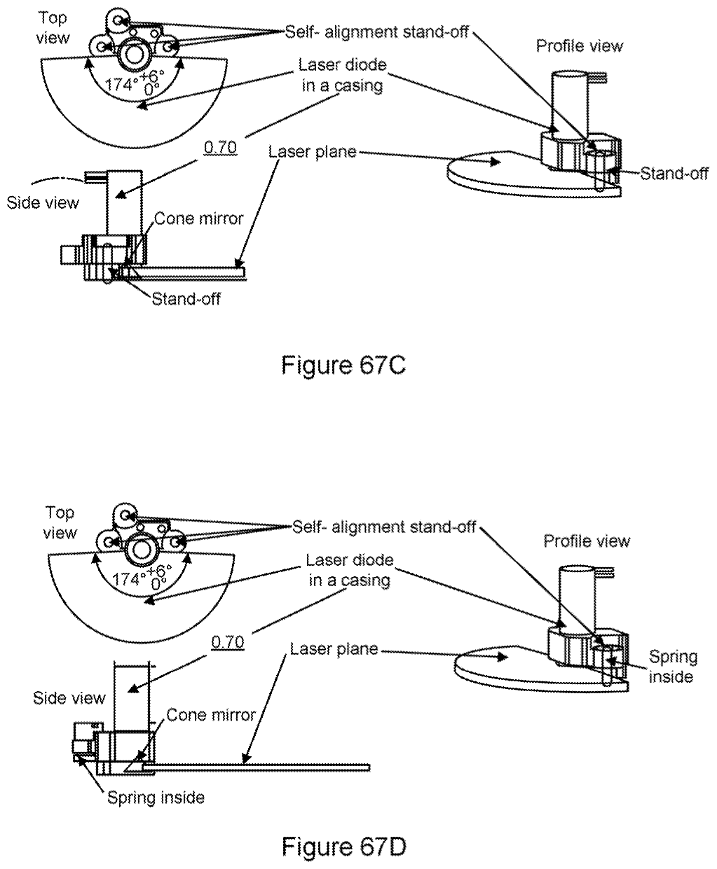

In some embodiments, a three-point alignment system will further allow the user/assembler to align the beam once it is assembled into any device, regardless of the deformation or production error of the mounting base or the unevenness of the surface. As discussed further below, the three-point alignment system can even help tilt the laser plane slightly forward to avoid projection offset on the far end. Example three-point alignment systems are shown in FIGS. 67B-67D.

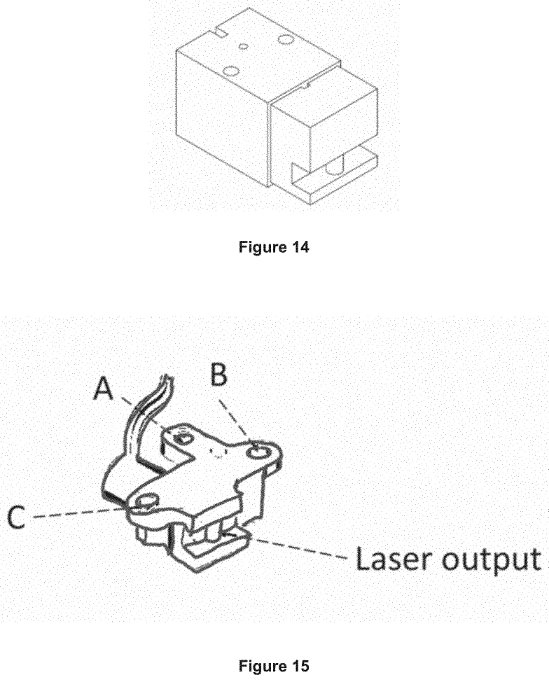

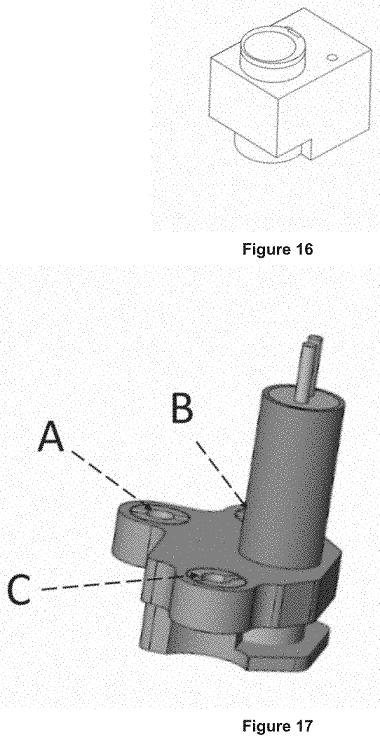

One embodiment provides a laser plane generator that includes a cyclidic lens and a three-point alignment system as shown in FIGS. 14 and 15. A cyclidic lens is a special cyclidic shaped lens that can direct the incoming light out to a very wide angle, e.g., up to 160 degrees. To make this type of laser generator, a laser diode is placed behind one or more lenses. An oval shaped laser beam is formed through these lenses and then shot directly onto the cyclidic lens. The cyclidic lens directs the laser out in 160 degrees. A thin laser curtain then is created just above the surface. Similarly, a three-point alignment system can be used to further fine tune the alignment during assembly. Either a spring, or a silicon pad can be used when mounting the unit on to the base.

One embodiment provides a laser plane generator that includes multiple light sources combined in a single block to cover larger areas as shown in FIG. 19. Multiple laser plane generators can be daisy-chained to cover larger areas. The generator shown in FIG. 19 includes a visible laser to help an installer to align the system.

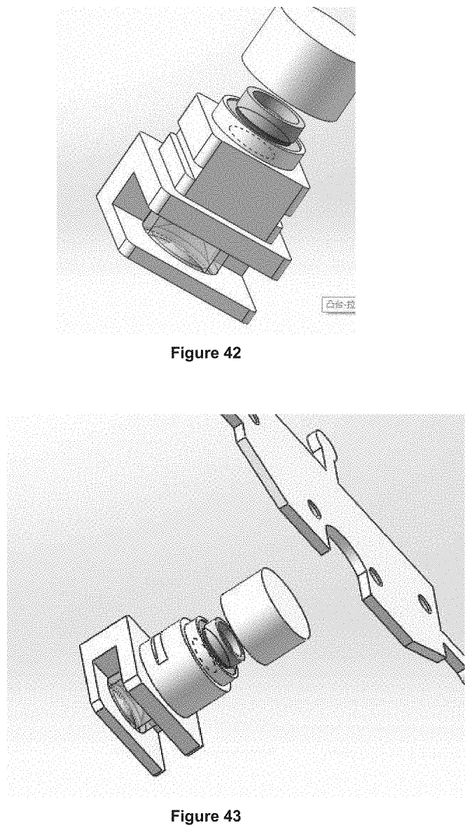

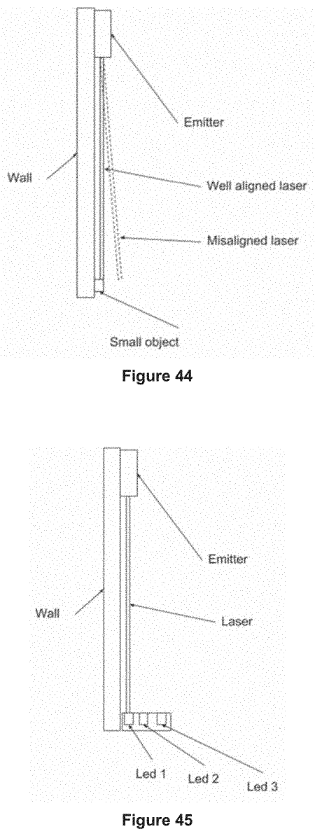

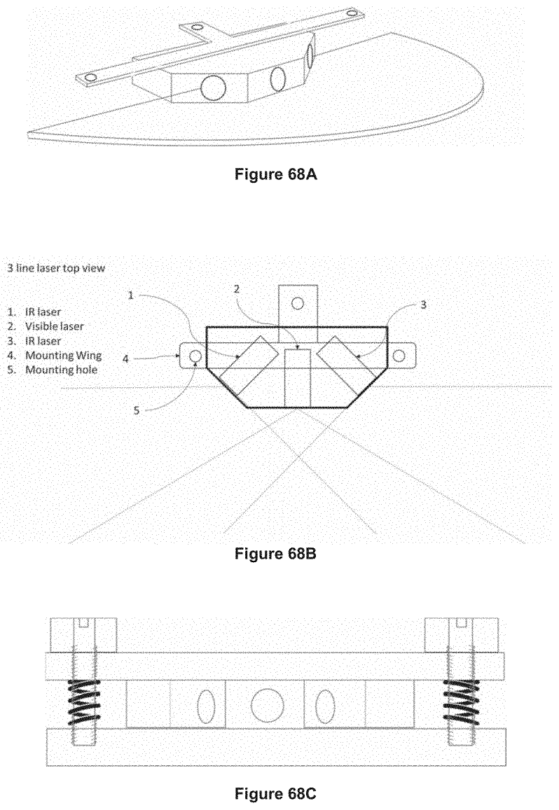

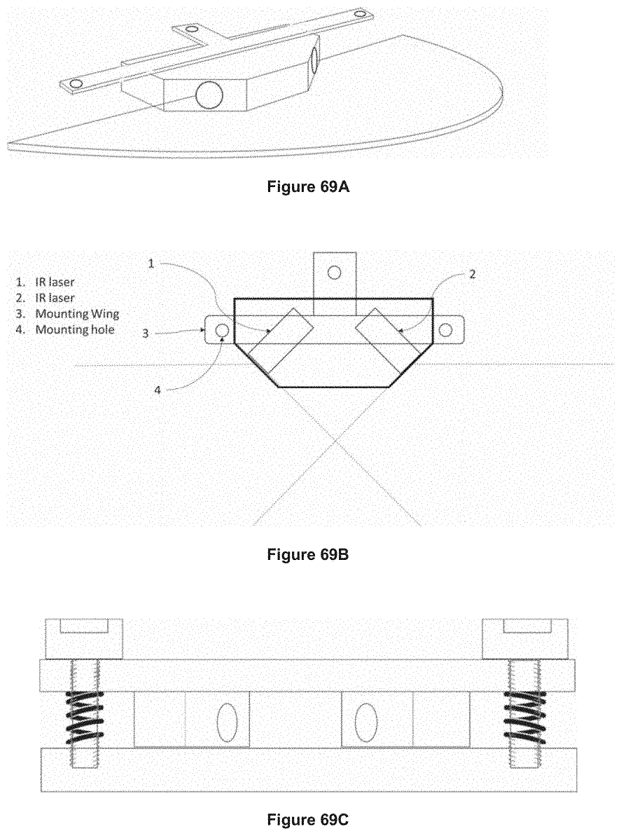

One embodiment provides a wing-shaped mechanism to align the laser plane generator as parallel to display surface as possible as shown in FIGS. 41, 43, 68A-680, and 69A-69C. A T-shaped wing can be attached any laser generator to add a three-point alignment system. The three tips of the T-shaped wing can be suspended on the spring, and a screw can be used to push down one tip of the wing to tilt the laser generator slightly. Since a screw can provide very high precision of transverse, the laser plane generator can be tuned precisely flush against the surface.

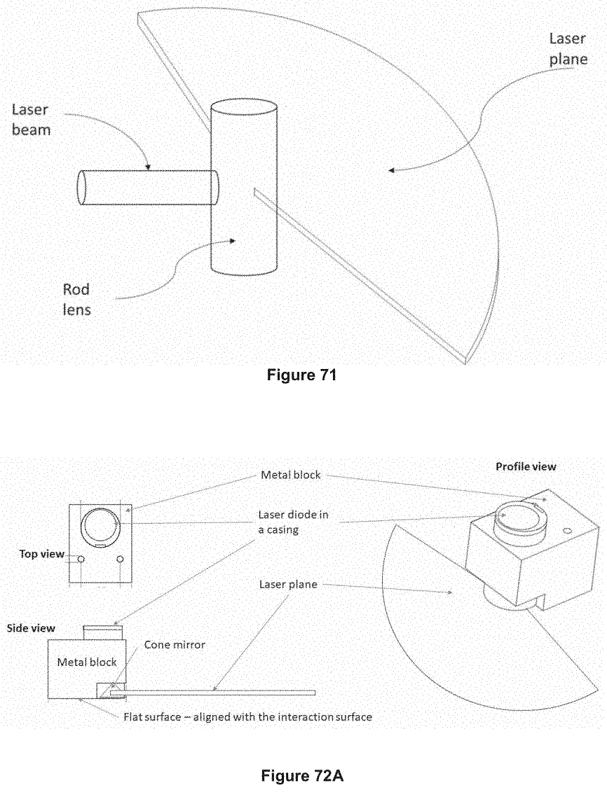

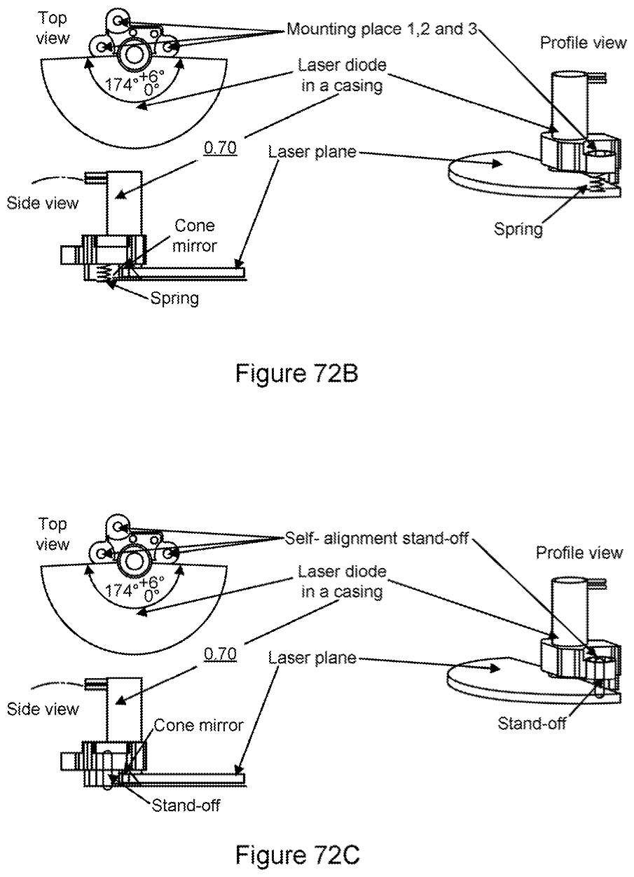

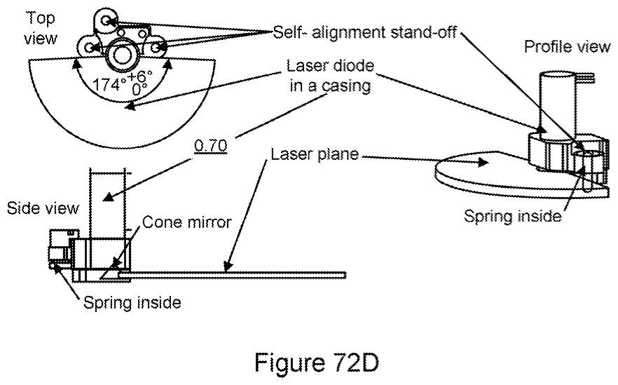

In some embodiments, a rod-shaped lens can be used in place of the cone mirror discussed above. FIG. 71 illustrates the operation of a rod lens. Rod lenses are a special variant of cylindrical lenses in that they are complete rods where the light passes through the sides of the rod and focuses a line. Rod lenses have an outside face that is polished and the ends ground. A laser beam passes through the rod lens (placed vertically) and becomes a laser plane. The rod lens can also be replaced with a line-generating-Fresnel-lens. FIGS. 72A-72D illustrate views of example rod mirror-based laser plane generators that utilize different alignment structures, as discussed herein.

One embodiment provides a mechanism to give feedback to the user on the alignment of the laser plane generator using a visual laser. As shown in FIG. 19, an example laser plane generator includes a unit that can generate a laser beam in visible spectrum. This visible laser beam will have physical characteristics such as beam height, thickness, angle etc. that is comparable or similar to that of the invisible laser beam used for interaction. When the user is aligning the laser beam, this visible beam gives the user a feedback on the physical positioning of the invisible laser beam. Optionally a mechanical or software switch can turn on and off the visible laser so that it is present only when the laser generator is being aligned.

One embodiment provides a mechanism to give feedback to the user on the alignment of the laser plane generator using a laser signal detector. As shown in FIG. 45, a physical device that can sense the invisible laser beam is used to detect the angle and strength at which the laser beam is projected from the laser generator. The visible indicators on this device (e.g., light emitting diodes) let the user know at what angle the laser is hitting the device. This device can be moved along different areas of the surface to see the alignment across the whole surface. The same device can also detect the strength of the laser beam at different areas of the display.

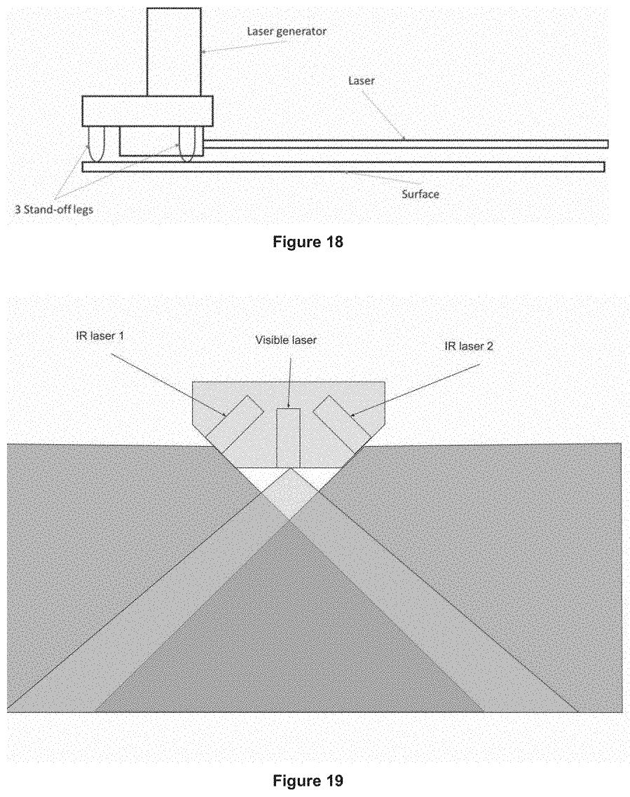

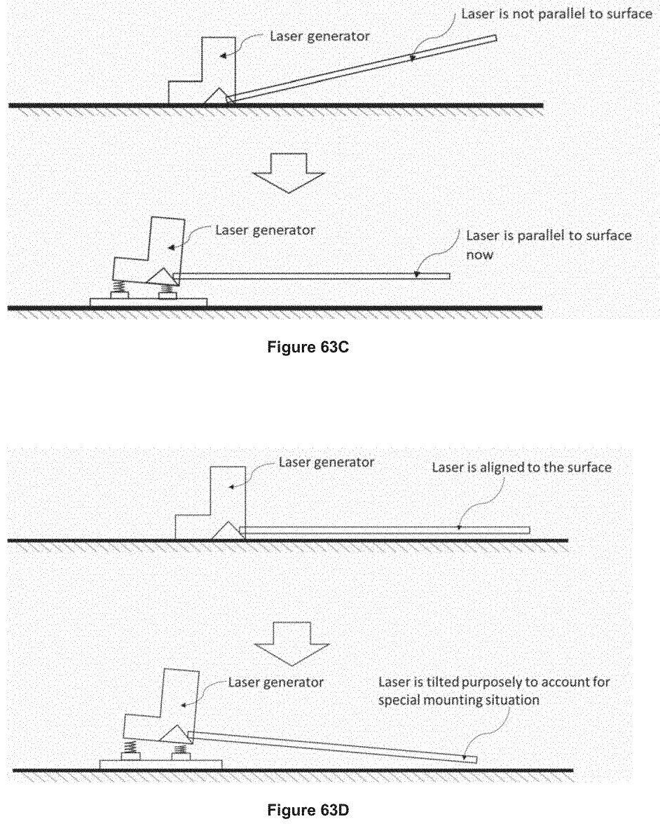

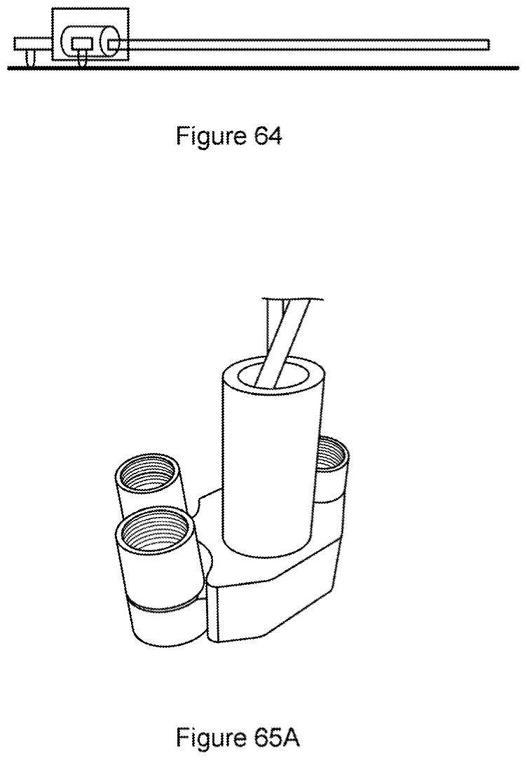

One embodiment provides a mounting mechanism for the laser generator. It is important that the laser beam is parallel and flush against the display surface. In order to obtain this condition, the laser generator must be mounted precisely on the body of the device holding it. However, this may still not be sufficiently accurate. In some embodiments, the laser generator is aligned using the display surface as the reference plane. For example, as shown in FIG. 4, a loaded spring can be used between the laser generator and its mount so that, when the laser generator is pushed against the surface, it will always remain aligned. In another embodiment, as shown in FIG. 18, standoff screws or legs are used as contact points between laser generator and the display surface to make sure it is aligned. FIGS. 63A-63D, 64, 65A-65D, 66, 67A-67D, and 72A-72D further illustrate the use of springs, screws, and/or legs to align a laser plane generator.

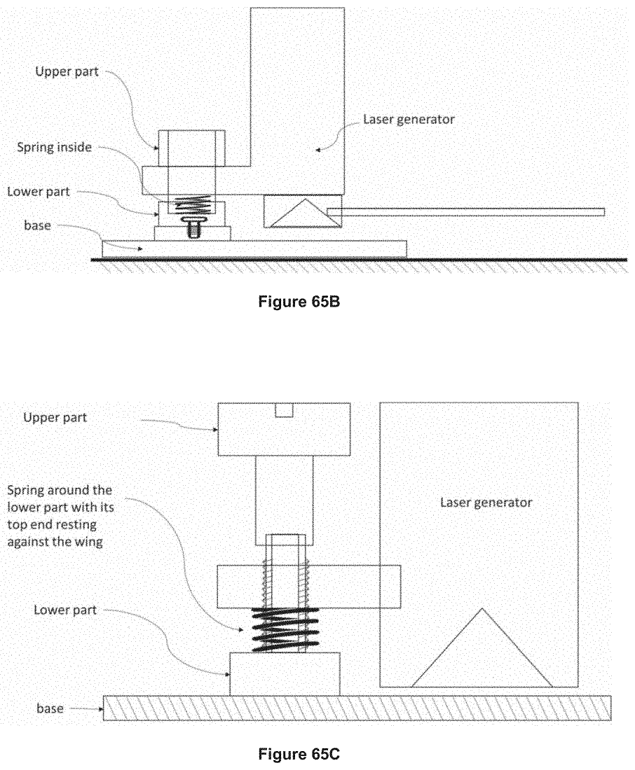

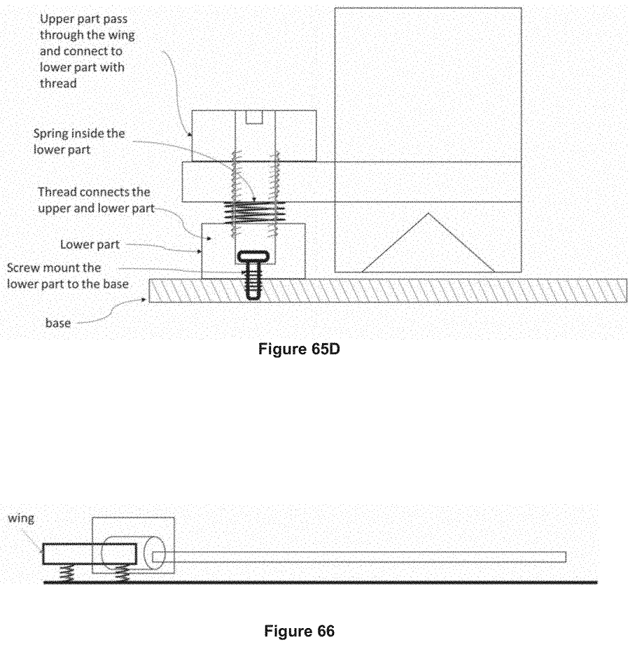

As noted, the laser plane generator may include three or more support components configured to support the laser plane generator on the display surface. Support components may be or include legs, springs, screws, or the like. The support components may be independently adjustable to modify the orientation of the laser plane generator with respect to the display surface. In some embodiments, each of the support components includes a screw operable to adjust a length of the support component, thereby raising or lowering a portion of the laser plane generator with respect to the display surface. In some embodiments (see FIGS. 65A-65D), each of the support components passes through a corresponding hole in the laser plane generator, wherein the hole has an axis that is parallel to the axis of the cone mirror, wherein each support component includes a top member, a bottom member, and spring, wherein the bottom member has a distal end that serves as a contact point between the support component and a support surface, wherein the top and bottom member are adjustably connected to each other and the spring biases the distal end of the bottom member away from the hole in the laser plane generator. In some embodiments, the bottom member includes male threads adapted to mate with female threads of the top member, such that rotating the top member with respect to the bottom member increases or decreases the distance between the distal end of the bottom member and the hole in the laser plane generator. Some embodiments (e.g., FIGS. 41, 43, and 68A) may include a wing-shaped, flat alignment member that is arranged on a plane that is perpendicular to the axis of the cone mirror, wherein the support components are attached to the alignment member.

In some embodiments, the laser plane generator can be turned on/off based on the use case to save power or to switch between input objects or interaction method.

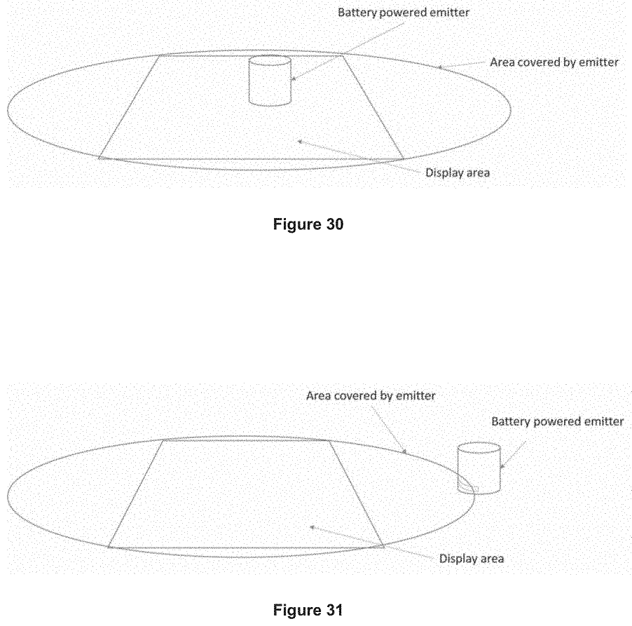

Some embodiments provide a battery powered laser module as shown in FIG. 30. The laser generator can be powered on by battery and placed on any surface or moved to other locations.

### Imaging Device

The imaging device should be able sense signals in the spectrum of the laser beam. In some embodiments, the laser is in the infrared spectrum and the sensor is an image sensor that is sensitive to this sensor.

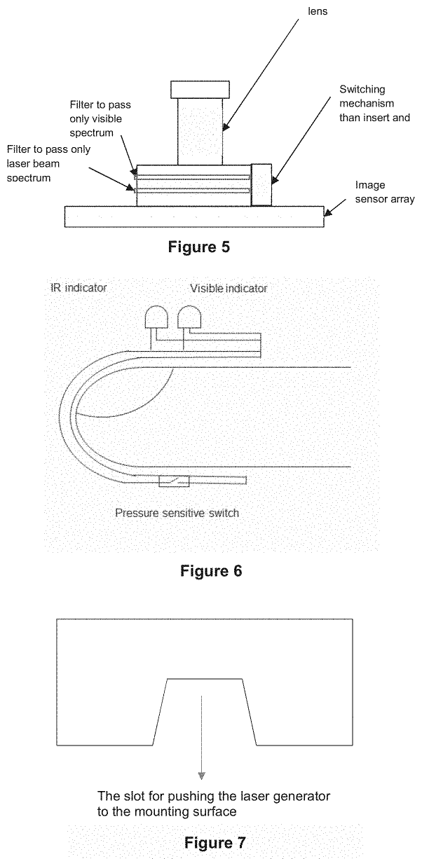

The imaging device in some embodiments can see both the laser beam signal as well as the visible spectrum. This will make sure that the sensor can detect the position of the display in its view so that it can match the position of the input object with the exact coordinate that the input object is on the display. There are several ways to achieve this such as using a depth sensor camera that can sense both visible and infrared spectrum and can map one to another. Another approach is to use a mechanical switch to switch between each spectrum. In some embodiments, a mechanical device such as shown in FIG. 5, is configured to insert and retract filters that blocks or passes infrared or visible spectrum. When the system is in calibration mode and needs to detect the position of the display, the software system will signal to the sensor to insert only the visible pass filter. When it is in the interaction mode and need to detect the input object, the software system will signal to the sensor to insert only the infrared pass filter. The signal can be sent from the software system using wireless signals or through a physical connection.

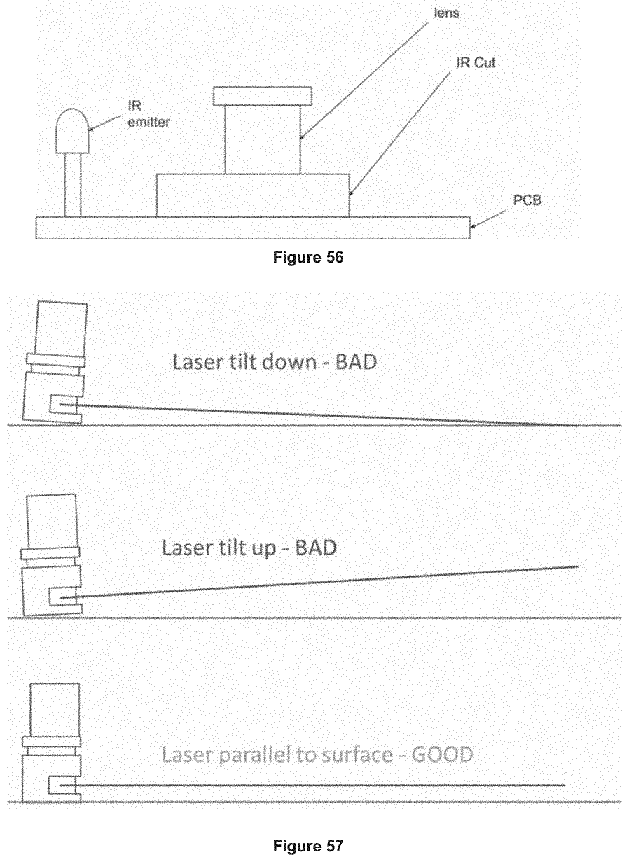

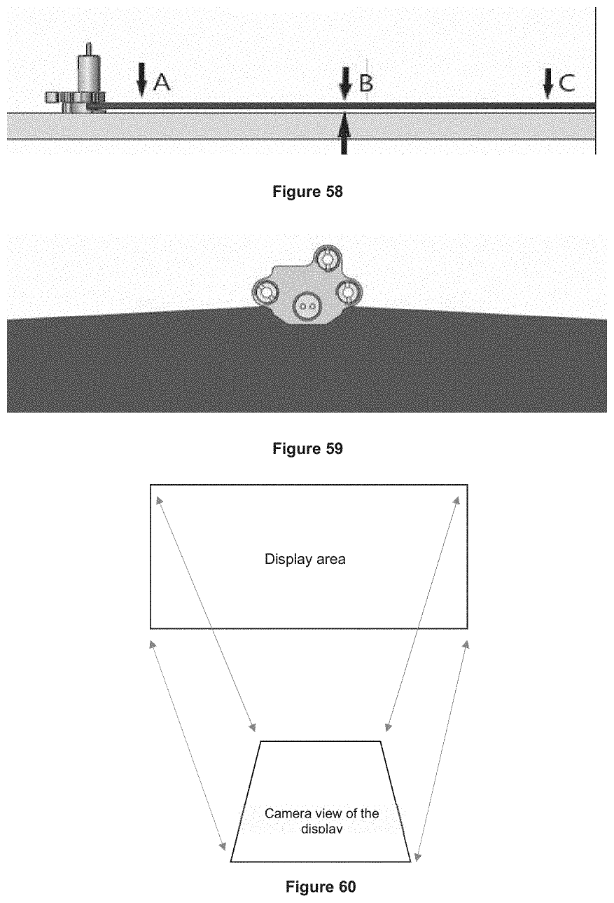

In some embodiments, the imaging device can control the laser plane generator. The laser plane generator needs to be turned on only when the system is in interaction mode. This helps save power and make the laser generator last longer. The power and the pulsing rate of the laser generator also can be controlled by the imaging device depending on whether the device is in active or inactive state or if the user is actively interacting or system temperature. The signal to the laser plane generator can be sent with a wireless signal or through a physical connection as shown in FIG. 56.

In some embodiments, the imaging device can look over the shoulder of the user. For the interactive screen system to work, the image sensor needs to have a clear unobstructed view of the input object. A special mounting mechanism is needed for this purpose, depending on the physical configuration of the system. The details of such mechanisms are described further below.

### Input Objects

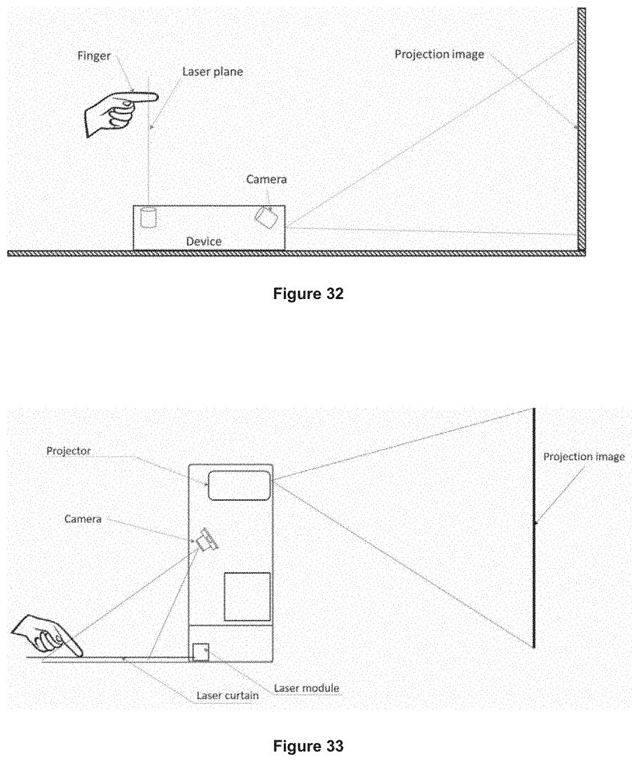

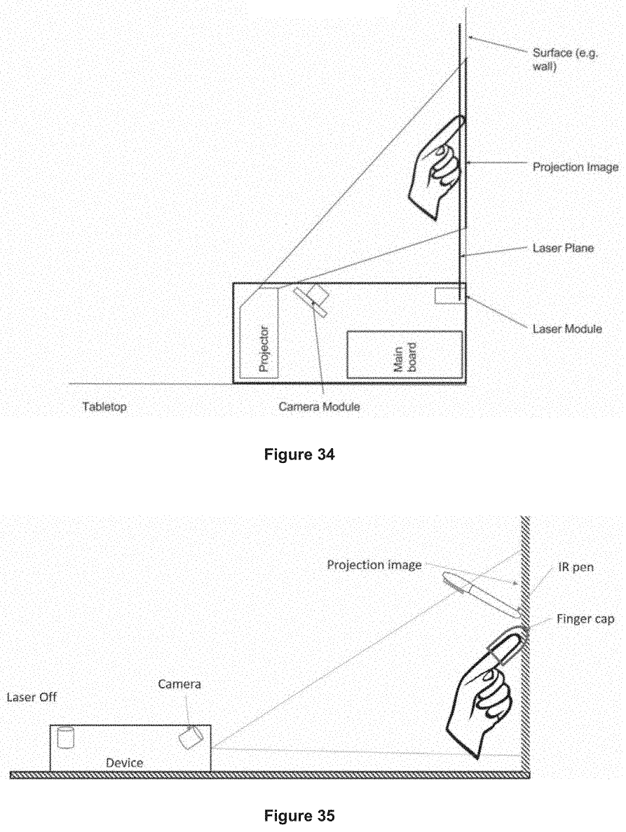

To interact with the system, the user can use different types of objects. In general, any opaque object (e.g., a finger, wand, pointer) that reflects the laser beam can be used for interaction. Finger-based interaction is shown in FIGS. 32-34. A passive stylus or pen like object with a reflective tip will assure that the imaging sensor will be able to pick up the laser beam signal reflected from its tip. A telescopic stylus is a wand very much like the passive stylus that be extended so that the user can reach even areas of the screen that is not easily reachable with fingers or passive stylus.

An active pen is a stylus like device that has a tip that can emit a signal from its tip that can be sensed by the image sensor. One of the main reasons to use the active pen is that it can trigger a different interaction experience for the user. An application can react differently to a pen input than a touch input. For example, when a pen is used, a presentation tool can switch to annotation mode instead of sliding mode. The pen has a pressure sensitive tip that can turn on an internal switch when it is pressed against a surface. The switch in turn triggers the pen to emit a unique signal. The signal can be a simple pulse in the same spectrum as the laser beam. The imaging device can then sense this signal and pass it as input to the software system. The size of the signal blob can be used as an indicator to distinguish the pen input from other input. Another option is that the pen transmits a wireless signal to the image sensing device or computing device. The pen can also transmit a time division multiplexed signal than can be unique to each pen, which makes it easy to distinguish the pens from each other and from other input devices. The active pen can also serve the purpose that it can trigger interaction even in the absence of the laser plane generator. In some embodiments, a telescopic pen is provided, which is an active pen with an extendible design.

A finger cap, shown in FIGS. 6 and 35, has a design that is similar to that of the active pen, except that it can be worn on the tip of the finger. The finger cap has a pressure sensitive switch at the fingertip. When the finger is pressed against the surface, it can trigger and emit a signal that can tracked by the imaging device. The finger cap can thus be used to create a portable interactive screen on any display. The user can wear multiple finger caps at the same time. The finger cap can also optionally have visible indicators to let the user know that it is “on” and its status. Other input methods including tracking pad and buttons can be embedded into the device to use when user is far away from the display.

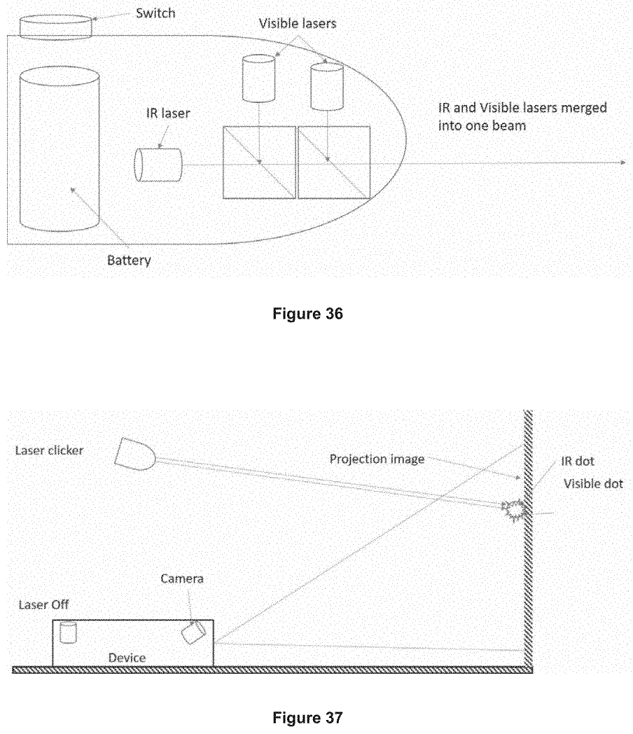

As shown in FIGS. 36 and 37, some embodiments provide a laser clicker with multiple wavelengths, including both visible and invisible lasers. The visible lasers give user a hint of where the interaction is happening and what interaction is happening (e.g. red is left click, green is right click), and the invisible light will show a blob on the screen that can be detected by imaging system.

In general, all electronic input objects can have a wireless module communicating with the host device to indicate an identifier so that multiple input objects can be tracked and distinguished.

### Software Processes

The software performs the following key functions—analyze the image captured by the imaging devices to detect the position of the display and detect the positions of the input objects on the display, generate touch output that can be accepted by any application. The software can be run on a computing device that is dedicated for its functionality or it can run on the computing device that is connected directly to the display.

In some embodiments, the interactive system includes only one imaging device and laser plane generator. In this embodiment, each time the software is started, or the interactive system is connected it performs the following functionalities.

Autofocus: Traditionally most projector systems have a way to focus its optic systems either manually or automatically. In the automatic focus system, there is a dedicated camera that looks at the projected display and based on the view determines if the optics of the projector is focused or needs adjustment. The interactive system can do this using its imaging device without having to rely on additional cameras. Every time the system starts or detects physical change in the environment (using motion, range sensors etc.), the imaging device switches from interaction mode to autofocus mode where is starts capturing a visible view of the display. Based on the sharpness of the projected display, the interactive system adjusts the focus of the optic system of the projector. This is an optional functionality and needs or can be used only with projection display.

Auto-keystone correction: Traditionally most projector systems have a way to correct the shape of the projected display either manually or automatically. In the automatic key stone correction system, there is a dedicated camera that looks at the projected display and based on the view determines if the optics of the projector is focused or needs adjustment. The interactive system can do this using its imaging device without having to rely on additional cameras. Every time the system starts or detects physical change in the environment (using motion, range sensors etc.), the imaging device switches from interaction mode to auto key stone correction mode. By detecting the geometry of the projected display, it can correct the projected display image to make sure it appears always rectangular. This step optionally can be combined with the calibration and autofocus stage.

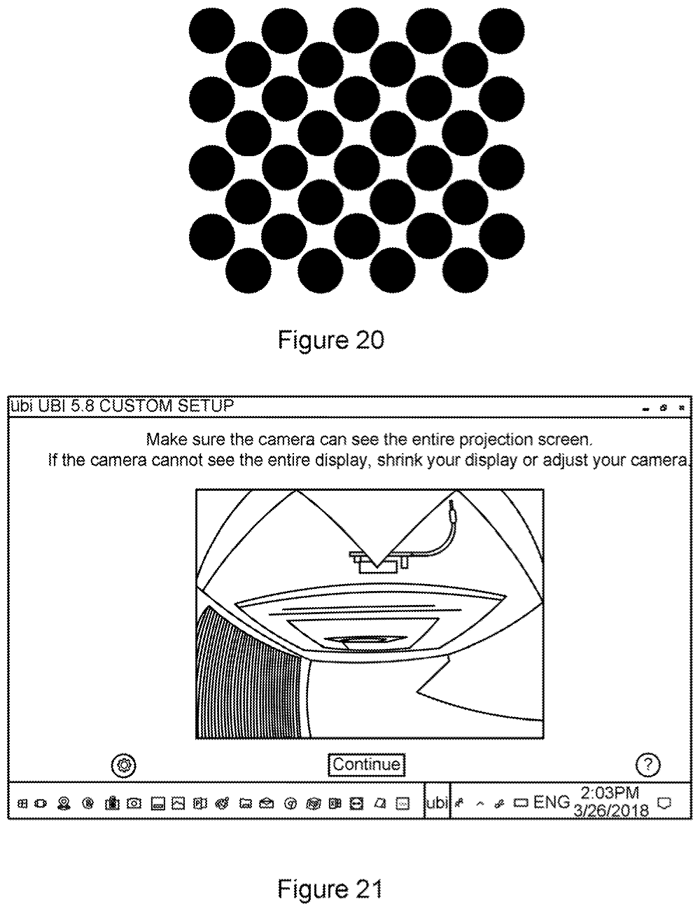

Calibration: Calibration is the process by which the imaging device detects where in is view the display is. This functionality needs be performed only if the physical position of the display surface, imaging device and display changes with respect to each other. Calibration is done by displaying one or more patterns on the display and capturing it with the imaging device. In some embodiments, the calibration is done with a single asymmetrical pattern whose view can be used to detect position and orientation of the display with respect to the imaging device. A sample embodiment of such a pattern is shown in FIG. 20.

A multiple-step calibration that involves displaying and capturing the view of multiple pattern images can also be used to make the detection process more robust and precise. In one such embodiment a simple, easy to detect pattern is used first. This will help roughly identify the corners of the display which can be used in later phases of calibration to warp the camera view and remove background clutter. This makes the later phases more precise and less prone to error. In another embodiment, the same pattern can be displayed with various intensities and color patterns to make it detectable in varying light environments.

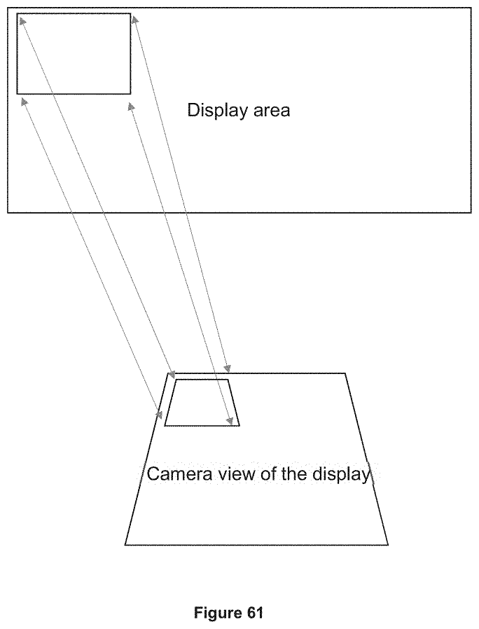

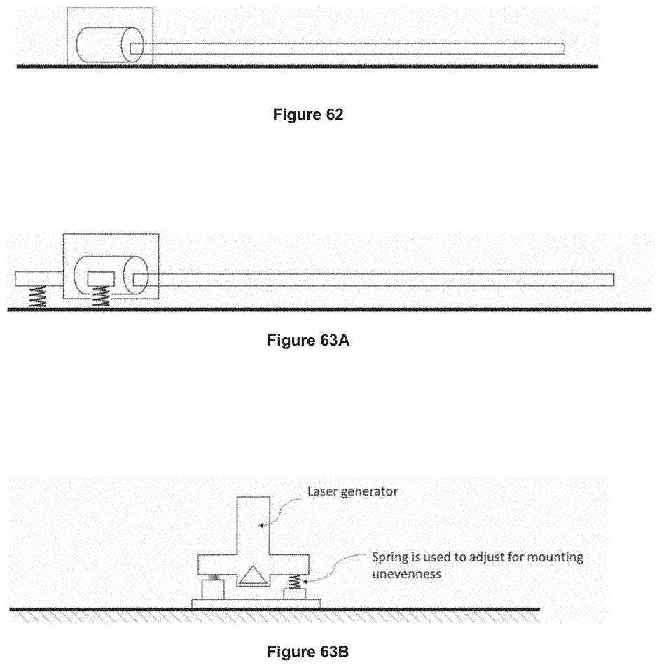

In some embodiments, the calibration detects the four corners of the display and forms a homographic relationship between any point within this display and the actual display coordinates, as shown in FIG. 61. But this can be true only if the detected view of the display follows plane homographic relationship. However, when using wide angle optics on the image detection device, this is usually not true even after compensating for distortions. Therefore, the display needs to be split into smaller regions so that in each region, planar homographic relationship can be assumed as shown in FIG. 62.

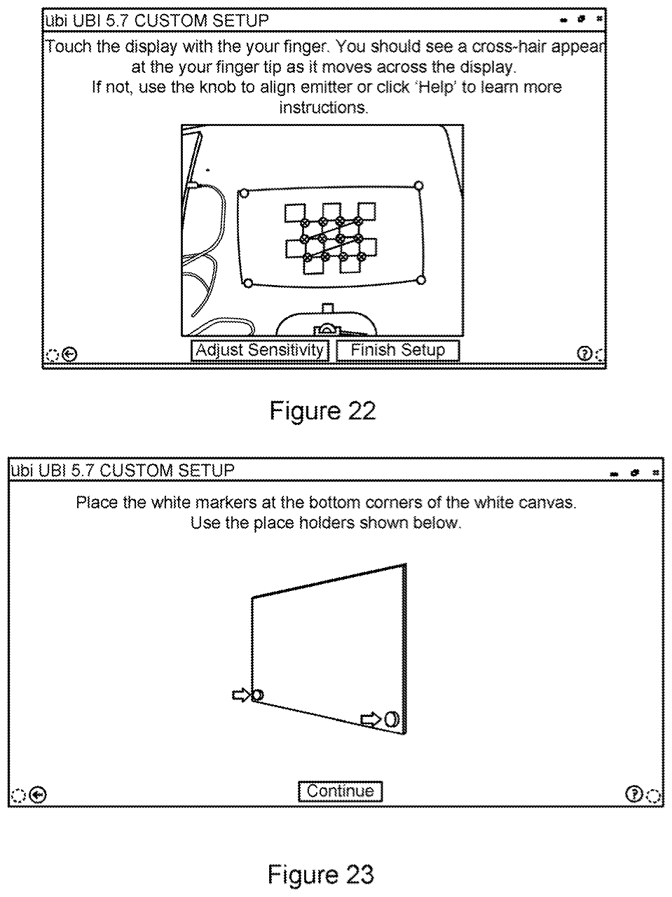

A key part of making calibration successful is giving the user feedback on the process. Before calibration starts the user should be shown a view of the imaging device. This helps the user in making sure that the imaging device has a clear view of the display, as shown in FIG. 21. In this step, the user can also let the system know the rough position of the display within the view of the imaging device. In one embodiment, the user will select four corners of the display as shown in FIG. 22. This will help the calibration become more robust and precise.

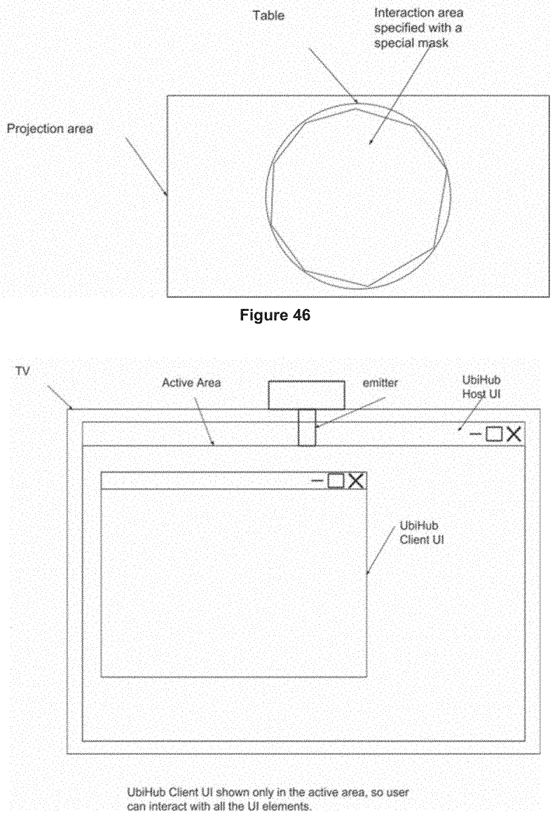

In another embodiment, the display can have a shape that is not rectangular. In this case the calibration pattern displayed can be customized by specifying the exact shape of the display surface as a series of points. The calibration pattern's shape will be modified accordingly as shown in FIG. 46.

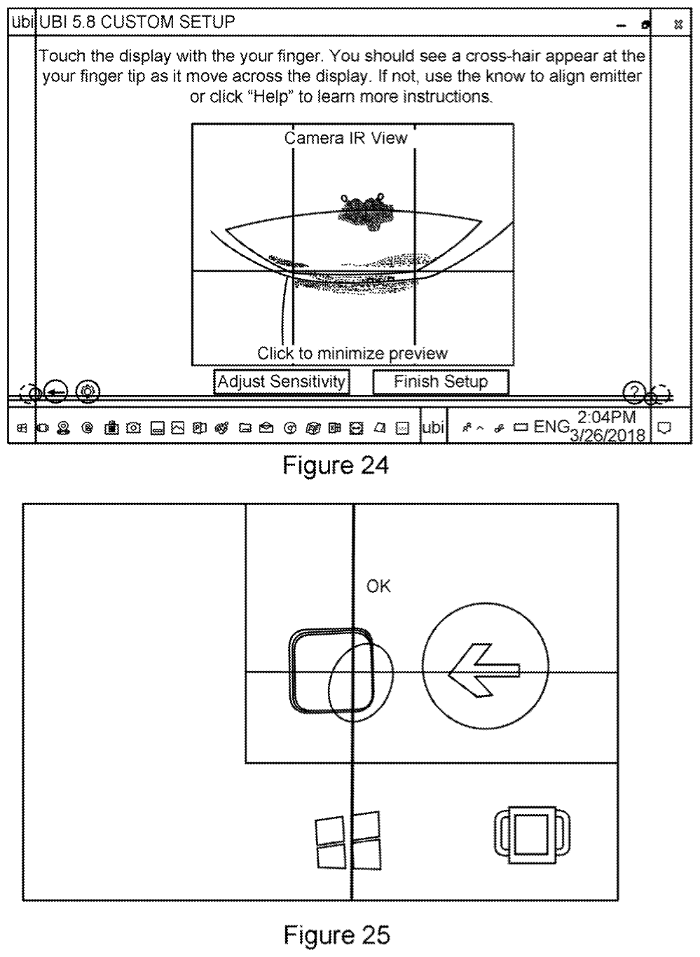

Alignment of the laser generator: As explained in the section ‘Laser Generating Device”, for the interaction experience to be smooth the laser generator needs to be aligned flush and parallel to the surface. The various mechanisms to do this also has been explained in that section. During this alignment phase, the system guides the user on how to perform the alignment accurately. The first part of this is showing the user the view of the laser signal as seen by the imaging device, as shown in FIG. 24. The system marks all coordinates on the screen where it detects an input object as see in the figure. The user is then asked to place special “calibration markers” on the display. These calibration markers are objects with the height matching the elevation of the laser plane. When the laser plane is aligned well, it will hit the calibration object and show a visual feedback letting the user know that there is an object detected there, as shown in FIG. 25. Once two or more calibration objects are detected as input object, the user can be reasonably sure that the laser plane is aligned.

Background registration: If there is an object that be mistaken as an input object in the display area, the interactive system should be smart enough to avoid issuing touch input at the location of this object. This is done by building a background object model just before touch inject starts. The background model will account for signals from laser plane reflected by background objects

Fine tune sensitivity: When an input object is present in the display area, it creates a blob that can be detected by the imaging device. The size, shape and the intensity of the blob depends on the type of input object, position of the input object on the display with respect to the imaging device and laser generator. The blob especially becomes bigger and brighter as it physically touches the surface. For each physical configuration of the interactive system, a sensitivity profile can be created that precisely describes the size, shape, intensity and other characteristics of the blob created by the input object when it physically touches the display surface. In order to maximize the interaction experience, interactive system assumes a sensitivity profile for each configuration. In one embodiment the interactive system divides up the whole display into a finite number of zones and creates a profile for each zone. The user can manually specify the sensitivity profile for each zone and for each input object. In another embodiment, the interactive system can dynamically detect the sensitivity profile. It will prompt the user to touch different parts of the display to take samples of the sensitivity profile and based on this information, the system will create a sensitivity profile.

Input detection: When an input object is present within the display area and fits the sensitivity profile determined in the previous step, an input object is considered to be detected. The sensitivity profile can be used also to distinguish between the different input objects. For example, a bigger brighter blob may be classified as an active pen rather than a finger. A larger but equally bright blob can be classified as palm instead of a finger. Also note that if a custom shape of the display has been detected or specified, the system will limit detection only within that area or areas around the display, as shown in FIG. 46. Based on the size and shape of the input blob generated by the input object, the touch output generator can classify it as an over action or touch action.

Touch output generation: Once an input object has been detected the interactive system will issue a touch event to the operating system of the computing device. Depending on what input object was used and what class of touch output was detected, the interactive system will determine what touch event to issue. For example, a finger can be interpreted as a standard touch object, an active pen can be interpreted as a stylus and palm can be interpreted as eraser. The touch output generator may also listen to other signals from input objects. For example, active pen may send signal in a different wavelength or using a different pulse or using a different wireless signal that is it active. This not only helps to identify stylus input from touch input, it may also help identify one stylus from another.

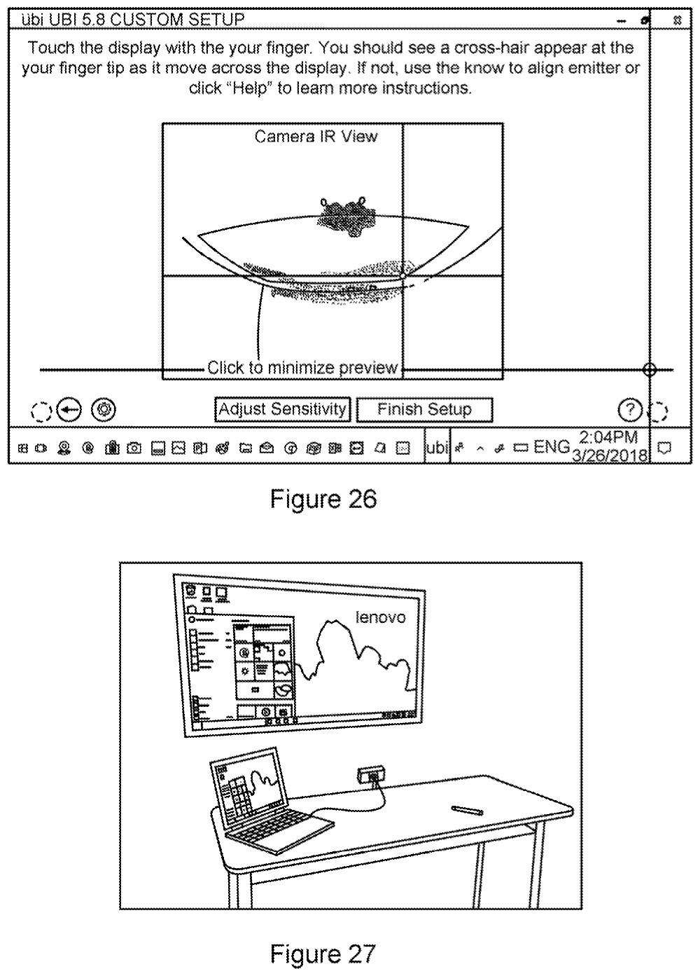

Check setup: When the interactive system is in interaction mode, the user may still experience problems with generating touch input. In order to determine what is wrong, the interactive system allows the user to go back to a special preview mode called “check set up”. In this mode, the user is able to see the detected input object and optionally more debug information, as shown in FIG. 26.

In some embodiments, as explained further in the section “Physical setup”, the user can connect multiple imaging devices to the same computing device. This could be to expand the interaction area to avoid occlusion. In this embodiment, the interactive system modifies the flow of its operation. For each imaging device, it performs calibration. The calibration can be done simultaneously or one by one. For each imaging device a fine tune sensitivity is also performed. Once input has been detected in the view of each imaging device, these inputs are blended together to avoid any duplicates. If more than one imaging device detects the same object, the data from these devices are combined to find the exact position of the input object.

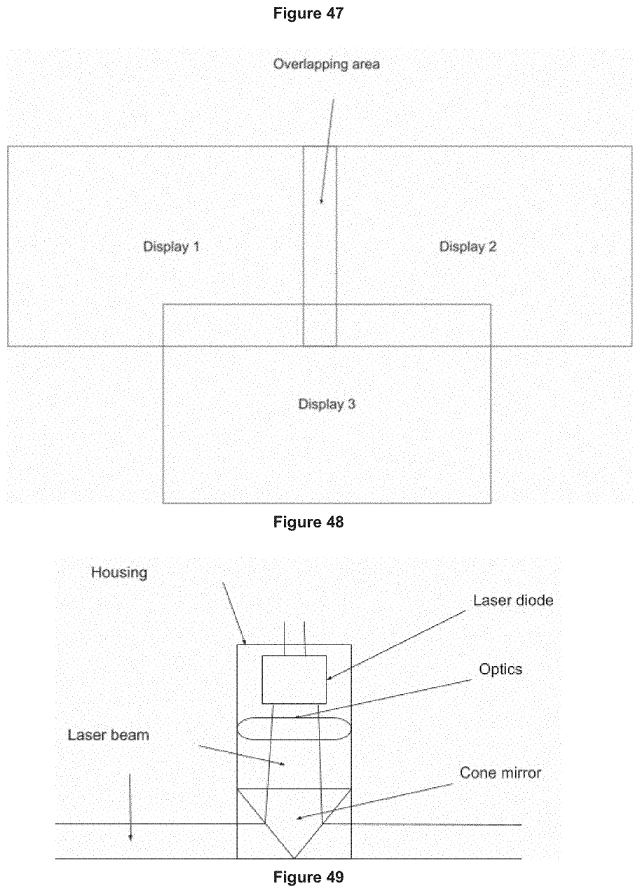

Interacting with connected devices: when one device is connected to the projector and imaging system, the content of the device will show up on the projector and become interactive. But the interactivity is not limited on this single device. Other devices (client) can wirelessly or through physical connection, connect to this device (host) and show content on the host and interact with it. An example embodiment is shown in FIG. 47. In this sample embodiment, the host will show its public IP and the client can connect to the host via network. Multiple clients can connect to the same host to enable collaborative work on one single display. Contents can be shared between devices visually by dragging from one device to another device. The data transmission happens through the network.

### Physical Set Up

A variety of physical arrangements are supported, as discussed below.

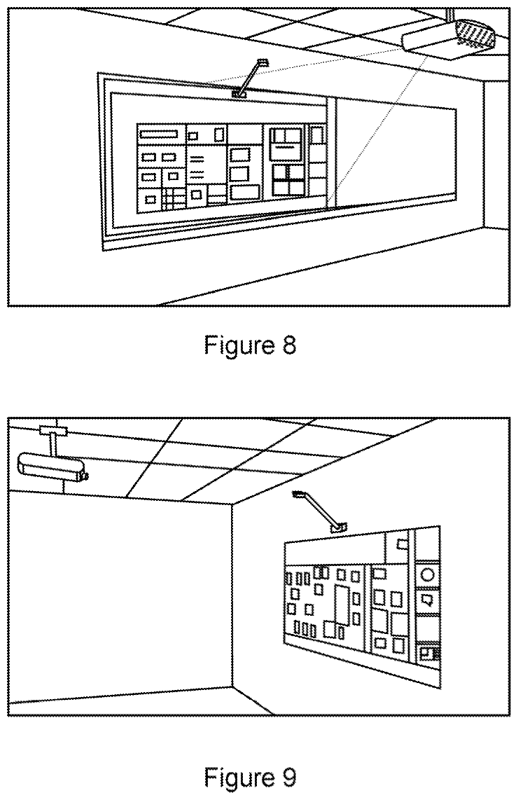

Whiteboard: In conference rooms and classrooms, one of the most commonly available flat surfaces is a whiteboard. A projector can display image on the whiteboard. In order to provide an occlusion-free interaction, the imaging device needs to be placed as close to the surface as possible, almost as if it is looking over the shoulders of the user. An embodiment that can enable such an interaction is shown in FIG. 8. A key aspect of this design is the use of an arm like structure that is mounted on a base. This allows the image sensing device to have an occlusion free view. The base of the arm has a magnet at its back which makes attachment to the whiteboard easy. The base also holds the laser generator. The laser generator itself has a magnetic back end if it is not already embedded in the base.

Vertical projection surface: The set up on any vertical surface such as wall can be similar to the one on the whiteboard as can be seen in FIG. 9. A key difference is that walls are not magnetic. Therefor a metallic plate can be first pasted on the wall on which the magnetic base of the image sensor base and emitter can be attached. The metal plate can however stop the laser generator from being flush on the surface. This can be avoided by leaving a slot on the metal plate through which the laser generator can be pushed flush against the surface. An embodiment of such a base plate is shown in FIG. 7.

Ultra-short distance projectors: When the projector is mounted on the wall, there may be limited space to install the sensing device arm as shown in FIG. 29. A better option is to mount the device directly on the projector using a swivel base that can rotate with six degrees of freedom to make sure it has complete visibility of the projected display.

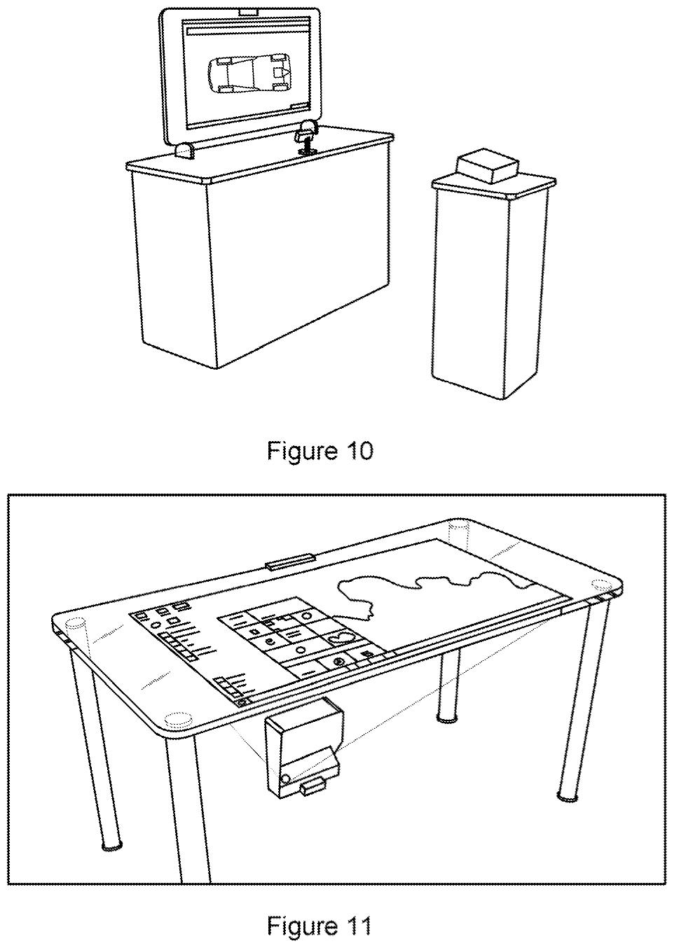

Rear projection: Rear projection is created by placing a projector behind a special film. To turn such a display interactive, user can mount the laser generator on the top edge of the projected display. The imaging device can be placed in the front or back of the projection. This is possible because the imaging device can detect the signal from the laser generated even through the projection film. During the calibration process, the software can automatically or with user input detect whether the imaging device is placed at the back or front of the display. An embodiment of such a system is shown in FIGS. 10 and 11.

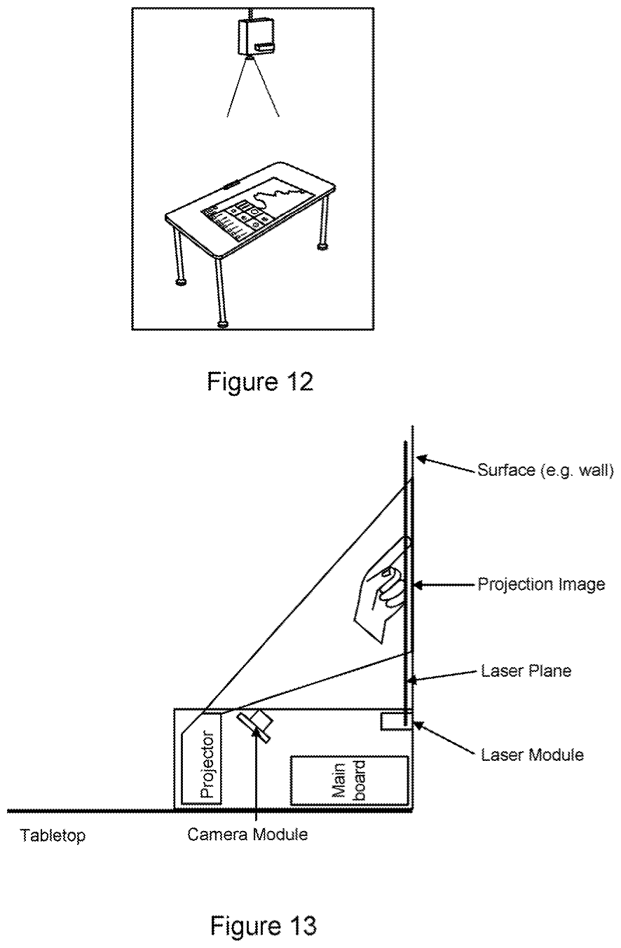

Horizontal projection surface: When the projection is on a horizontal surface, it can follow the same physical set up as the one explained under vertical surface and ultra-short distance projector. This is true whether the projector is mounted on or next to the table or is mounted much higher for e.g. on the ceiling. When the projector is mounted on the ceiling, however, it is better to attach the imaging device directly on the projector. For this the optics on the imaging device can be matched with that of the projector as shown in FIG. 12.

Portable set up: As shown in FIG. 27, the imaging device can be placed in front of the display so that it can be easily placed and removed. The laser generator can be optionally placed at the top or bottom of the display. The user can also interact with an active pen if the laser generator is not used.

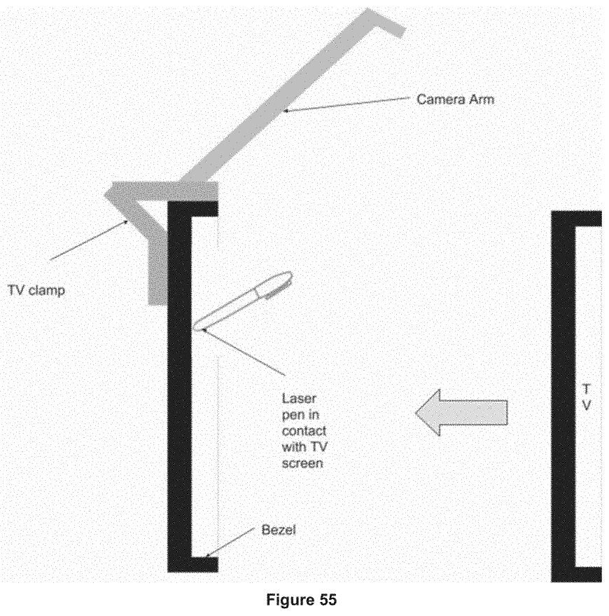

Physical display with pen only interaction: As shown in FIG. 55, the interaction is enabled on a physical display panel. In order to mount the imaging device on the physical display panel, a very flexible yet stable arm holding the imaging device is designed as shown in FIG. 55. In this set up, there is no laser generator and user can interact with pen.

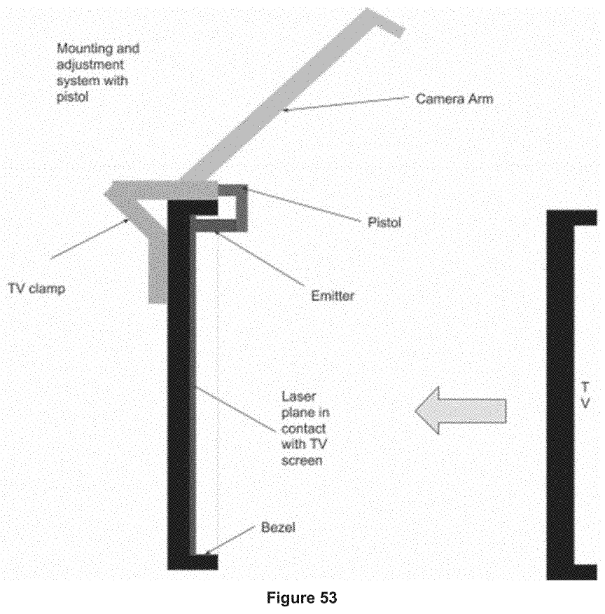

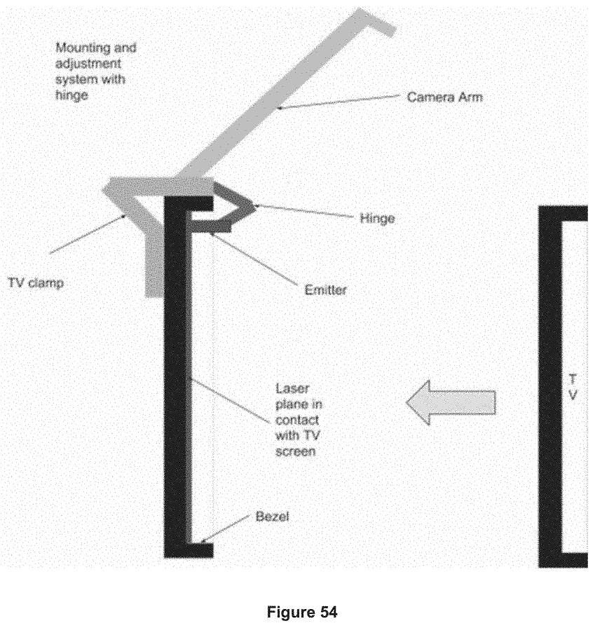

Physical display with touch interaction: In one of the embodiments, the interaction is enabled on a physical display panel as shown in FIG. 53. In order to mount the imaging device on the physical display panel, a very flexible yet stable arm holding the imaging device is designed as shown in FIGS. 53 and 54. In this set up, the laser generator is also attached on the display panel. In order to make this happen, the laser generator needs to be attached directly on the physical display panel. In one of the embodiments the laser generator is directly pasted on the bezel of the display panel. However, the interaction experience may not be optimal in this case as the laser generator is not flush against the display surface.

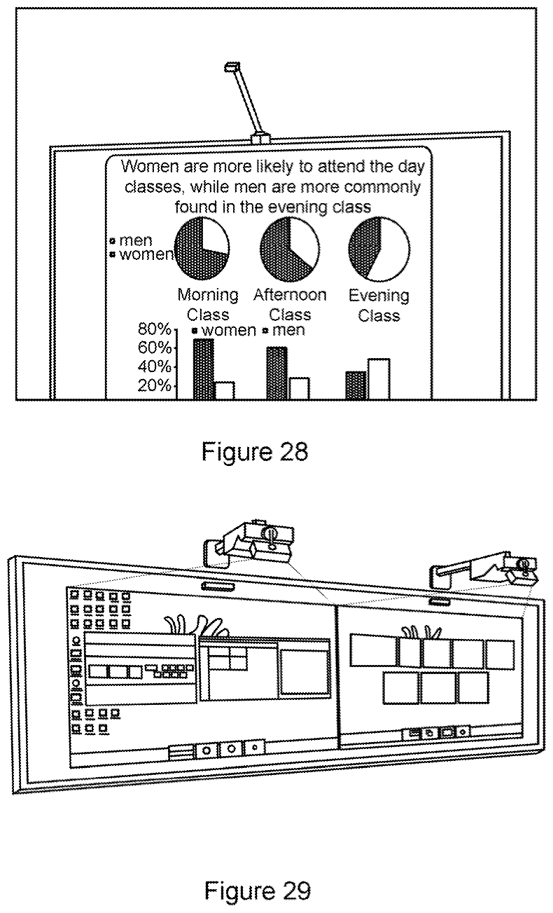

In another embodiment, the laser generator is placed directly on the display panel and attached to the base of the imaging device using a hinge as shown in FIGS. 28 and 54. The hinge shown in FIG. 54 will allow to place the laser generator flush on the display panel and align it perfectly, irrespective of the size of the bezel. The hinge with multiple joints allows enough degrees of freedom for the alignment. In another embodiment, the laser generator is aligned attached using a piston as shown in FIG. 53.

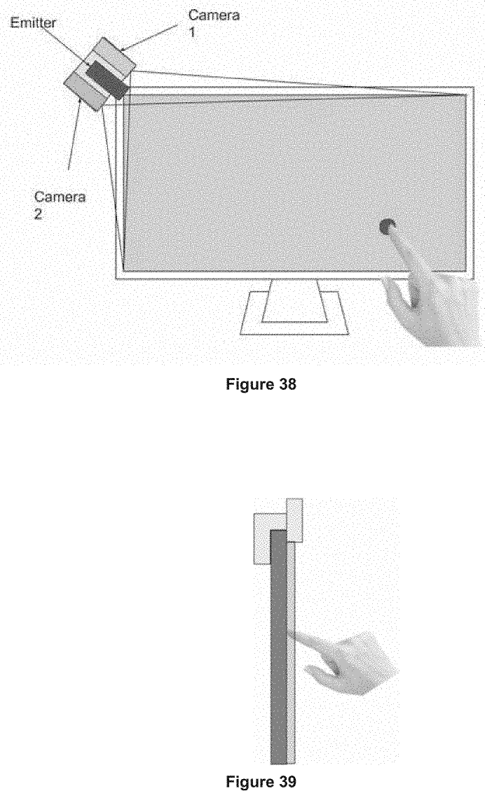

In another embodiment, the imaging device and the laser generators are attached in a corner of the physical display panel as shown in FIG. 38.

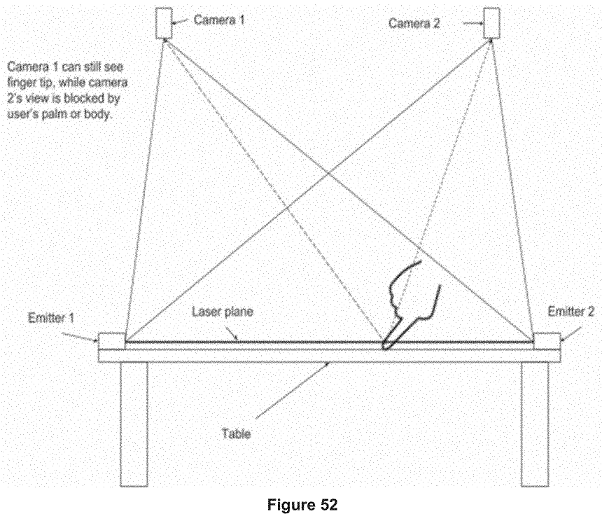

Single imaging device, multiple laser generators: The strength of the laser generator limits the maximum size of the display it can cover. In some of the embodiments, multiple laser generators can be used to cover a larger area, as shown in FIG. 29. In another embodiment, multiple laser generators are used to make sure that the input object receives a signal from one of the laser generators without occlusion, as shown in FIG. 52.

Multiple imaging devices, multiple laser generators to expand interaction area: The strength of the laser generator limits the maximum size of the display it can cover. The view angle of the camera also limits the interaction area. In some embodiments, multiple laser generators and multiple imaging device can be used to cover a larger area, as shown in FIG. 29. There is no requirement that the imaging device and laser generator has a one-to-one matching.

Gesture control using laser plane: In another embodiment, the laser plane is not aligned against any surface. Instead it projects a laser plane in the air. When the user intercepts this laser plane by moving the input object in the air, the imaging device picks up this interaction. This can be used to control the computing system using specific gestures, as shown in FIG. 32. In some of the embodiments, this input method can be combined with the touch input method explained elsewhere.

Portable integrated device: In some embodiments, the laser generator and imaging device is used along with a projected display provided by a small form factor device, as shown in FIG. 2. The laser generator is mounted at the base of such a device. The device includes the generator, projector, and imaging device integrated into a single housing. When the device is placed vertically, it creates an interactive display on a horizontal surface. When it is placed horizontally and flush against a vertical surface, it creates an interactive display on the vertical surface, as shown in FIG. 13. When it is placed horizontally away from any surfaces, it creates a larger physical display. The user can then interact with gestures or a pen as explained above as shown in FIG. 35. In some embodiments, the portable integrated device may support other input mechanism such as voice recognition or an additional interactive screen.

Interactive track pad: In some embodiments, the interactive screen system is not turned towards the display surface. Instead it is set up on a different surface as shown in FIG. 33. In this configuration, the user input is detected on the interaction surface and works more like a track pad or mouse input on the computing system rather than a traditional touch input.

1. An interactive display system, comprising:
a laser plane generator that includes:
a laser plane generating device; and
a laser oriented to emit a beam of infrared light towards the laser plane generating device, thereby causing the laser plane generating device to produce a plane of infrared light; and
an imaging device that is configured to:
sense the infrared light produced by the laser;
detect a reflection produced by an object that breaks the plane of infrared light.

2. The system of claim 1, wherein the laser plane generating device includes a rod lens having a longitudinal axis that is perpendicular to the plane of infrared light, wherein the beam of infrared light causes the rod lens to produce the plane of infrared light.

3. The system of claim 1,
wherein the laser plane generating device includes a cone mirror having an apex, a circular planar base, and a lateral surface extending between the base and the apex, and an axis that passes in a perpendicular direction through the center of the base and the apex, and
wherein the laser is oriented to emit the beam of infrared light parallel to the axis and towards the lateral surface of the cone mirror, wherein the lateral surface of the cone mirror reflects the beam into the plane of infrared light, wherein the plane is perpendicular to the axis, parallel to the base, and between the base and the laser.

4. The system of claim 1, further comprising:
a projector configured to project an image upon a substantially planar display surface, wherein the plane of infrared light is parallel to the display surface.

5. The system of claim 4, further comprising a housing having a flat first end and a flat second end, wherein the projector and the imaging device are located at the first end of the housing, wherein the laser plane generator is located at the second end of the housing, such that when the second end of the housing is flush with the display surface, the laser plane generator is oriented to cast the plane of infrared light parallel to the display surface, the projector is oriented to project an image onto the display surface, and the imaging device is oriented to detect infrared light reflected by objects that break the plane of infrared light.

6. The system of claim 4, wherein the laser plane generator includes three support components configured to support the laser plane generator on the display surface, wherein each support component is adjustable to modify the orientation of the laser plane generator with respect to the display surface.

7. The system of claim 6, wherein each of the support components includes a screw operable to adjust a length of the support component, thereby raising or lowering a portion of the laser plane generator with respect to the display surface.

8. The system of claim 6, wherein each of the support components passes through a corresponding hole in the laser plane generator, wherein the hole has an axis that is perpendicular to the plane of infrared light, wherein each support component includes a top member, a bottom member, and spring, wherein the bottom member has a distal end that serves as a contact point between the support component and a support surface, wherein the top and bottom member are adjustably connected to each other and the spring biases the distal end of the bottom member away from the hole in the laser plane generator.

9. The system of claim 8, wherein the bottom member includes male threads adapted to mate with female threads of the top member, such that rotating the top member with respect to the bottom member increases or decreases the distance between the distal end of the bottom member and the hole in the laser plane generator.

10. The system of claim 6, wherein each of the support components includes a spring that biases the laser plane generate with respect to a support surface.

11. The system of claim 6, wherein the laser plane generator includes a flat, wing-shaped alignment member that is arranged on a plane that is parallel to the plane of infrared light, wherein the support components are attached to the alignment member.

12. The system of claim 4, wherein the laser plane generator includes exactly three non-adjustable stand-off legs configured to align the laser plane generator to the display surface, such that the plane of infrared light is parallel to the display surface.

13. The system of claim 1, wherein the plane generating device includes one or more lenses that are configured to produce a beam of infrared light that is oval in cross section.

14. The system of claim 13, wherein one of the lenses is a cyclidic lens.

15. The system of claim 1, wherein the imaging device is a camera that includes a mechanical switch that selects between infrared and visible light by inserting and retracting a filter.

16. The system of claim 1, wherein the laser plane generator includes a second laser configured to emit a beam of visible light.

17. The system of claim 1, further comprising a finger cap input device configured to be worn over the finger of a user, wherein the device includes a pressure sensitive switch that, upon receiving pressure from the tip of the finger of the user, activates an infrared signal that can be sensed by the imaging device.

18. The system of claim 17, wherein the finger cap input device includes an infrared emitter and a visible light emitter, wherein the infrared emitter produces the signal that can be sensed by the imaging device, and wherein the switch is further configured to activate the visible light emitter to produce a visible light signal.

19. The system of claim 1, further comprising a pointer input device that includes a switch, a visible light laser, and an infrared light laser, wherein the switch is configured, upon activation by a user, to activate the visible light laser and the infrared light laser to emit beams of light at a display surface, wherein a reflection of the infrared light beam can be sensed by the imaging device.

20. The system of claim 1, further comprising:
a first arm configured to hold the imaging device away from a display surface; and
a second arm configured to push the laser plane generator flush against the display surface.

21. The system of claim 1, further comprising a processor and a memory that stores instructions that are configured, upon execution by the processor, to:
calibrate the imaging device by causing a projector to project a pattern on a display surface, and capturing the displayed pattern with the imaging device;
align the laser plane generator by projecting a view captured by the imaging device on the display surface, wherein the view is marked with input objects detected by the imaging device;

22. The system of claim 21, wherein the instructions are further configured to align the laser plane generator by:
instructing a user to place calibration markers on the display surface, wherein the markers reflect light from the plane of infrared light when the laser pane generator is aligned to transmit the plane of infrared light parallel to the display surface;
detecting the reflected light from one or more of the display markers; and
projecting a visual feedback indicator onto the one or more display markers.

23. The system of claim 21, wherein the instructions are further configured to classify a detected input object based upon the size of a patch of reflected infrared light detected by the imaging device.

24. The system of claim 21, wherein the instructions are further configured to:
track interactions of a user with a display projected by a projector, wherein the interactions are tracked based on infrared light reflected by the objects that break the plane of infrared light;
calibrate the imaging device with respect to the projected display;
automatically adjust focal properties of the projector to modify sharpness of the projected display, based on images captured by the imaging device; and
automatically adjust optic properties of the projector to modify the shape of the projected display, based on images captured by the imaging device.
